(19) United States
(12) Patent Application Publication
(10) Pub. No.: US 2007/0263684 A1
(43) Pub. Date: Nov. 15, 2007

(54) Method and system for cooling and pressurizing an imaging head

(76) Inventor: John F. Nolan, Bradford, MA (US)

Correspondence Address: Agfa Corporation;Law & Patent Department, 200 Ballardvale Street, Wilmington, MA, 01887-1069, US

(21) Appl. No.: 11/430,682

(22) Filed: May 9, 2006

(51) Int. Cl. H01S 3/04

(52) U.S. Cl. 372/34; 372/36

(57) ABSTRACT

A method for cooling and pressurizing a laser imaging head includes the steps of: providing the imaging head with components including a laser source, a light valve for modulating light from the laser source, and optics for transferring an image to a medium; enclosing the imaging head within a non-hermetically sealed enclosure; and providing a flow of cooled air at a predetermined cool air temperature and at a controlled positive air pressure into the sealed enclosure through an inlet from a vortex tube operating from compressed air, wherein the cooled air flow and the predetermined cooled air temperature are controlled by the vortex tube to maintain an operating temperature of the components within the imaging head within a predetermined operating range, and wherein the positive air pressure is maintained within the sealed enclosure with respect to ambient air pressure outside of the sealed enclosure due to the controlled flow of cooled air entering the sealed enclosure.

### BACKGROUND OF THE INVENTION

This invention, in the field of pre-press and industrial printing, is generally directed towards use with any laser imaging system and head, and more specifically directed towards a method for cooling components and maintaining a clean operating environment of an imaging head used for imaging printing plates, such as on a platesetter, imagesetter, printing press or on-press imaging device.

The process of transferring text and/or graphic information from electronic form to visual form on a printing plate medium is called imaging. The information can be transferred to the medium using light such as produced by a laser beam or beams. The medium may be a printing plate that is sensitive to any wavelength, or to thermal imaging. The laser beam may be one that can provide ultraviolet light or high-powered intensity for thermal imaging.

Some thermal printing plates are imaged using an ablative process where an outer emulsion layer of the plate is removed using a laser beam having very high optical power. Other types of printing plates are thermally sensitive wherein an outer emulsion layer is not removed but is simply exposed to the laser beam to cause a chemical reaction, and also requiring a significantly high power laser beam. Still other plates have silver halide composition or are otherwise sensitive to exposure of various light frequencies such as, but not limited to, ultra-violet light.

Lasers are known low efficiency devices that require a large amount of input electrical power in order to provide modest levels of output optical power. The difference between the amount of electrical power provided to the laser beam and the output optical power generated by the laser is dissipated as heat. The laser power supply or source is often cooled or otherwise maintained within acceptable operating temperature limits for proper operation. Proper operation of the laser equipment requires removing the excess heat produced by the laser source. Failure to remove excess heat from the laser source can lead to the laser beam not meeting performance specifications. Consequently, the media will not be properly exposed yielding a defective product wherein the image is not completely transferred to the plate, or the image is distorted. Even worse, failure to remove the excess heat from the laser source can result in premature failure of the laser imaging system as is well known in the industry.

Other components of a laser imaging system or an imaging head, such as a light valve, also absorb energy from the laser beam and require cooling. The light valve is used to reflect, transmit and/or modulate the laser beam which is received from the source and then transmitted to the medium. When the laser beam is transmitted or reflected from a light valve, a certain amount of heat from the laser beam is absorbed by the light valve. If the laser beam intensity is too high or too much heat is absorbed, then the light valve can be damaged causing failure of the imaging head.

The laser light valve can be used to produce a plurality of individually controllable laser light beams. Two types of laser light valves are the Grating Light Valve (GLV™) produced by Silicon Light Machines, and the DMD™ micro-mirror light valve by Texas Instruments. Excess heat must be removed from the light valve to maintain proper operation and prevent failure.

U.S. Pat. No. 6,765,941 issued Jul. 20, 2004 to John Nolan solves the above problem of cooling both the laser source and a light valve modulator by disclosing an apparatus and method that uses chilled water flow to maintain proper operating temperatures of both components in the imaging head.

Specifically, Nolan discloses a method of cooling a laser system having a laser source, a light valve and a laser power supply that includes the steps of:

providing a single circulating unit having a tank for holding a supply of cooling fluid, and a pumping device operative for circulating the cooling fluid through the laser source, a flow rate sensor, a flow control valve, the light valve, the power supply and back into the circulating tank;

providing a first parallel flow path by serially connecting the laser source and the flow rate sensor together, and connecting a coolant inlet port deposed on the laser source to a coolant supply port of the circulating unit, and further connecting a coolant outlet port of the flow rate sensor to a coolant return port deposed on the circulating unit;

providing a second parallel flow path by connecting said coolant supply port of the circulating port of the circulating unit to a first port of the flow control valve, and serially connecting a second port of the flow control valve to a first port of the laser light valve, and serially connecting a second port of the laser light valve to a coolant input port of the power supply, and then connecting a coolant outlet port of the power supply to the coolant return port deposed on the circulating unit;

establishing flow of cooling fluid through each of the first and second parallel flow paths wherein a first flow rate of cooling fluid through the first parallel path is different than a second flow rate of cooling fluid through the second parallel path;

wherein the first rate of cooling fluid is determined by a size and number of cooling channels formed in a portion of the laser; and

wherein the second rate of cooling fluid flow is controlled by the flow control valve, the flow control valve further operative to maintain the second rate of cooling fluid flow constant.

Although Nolan's '941 patent solves the overheating problem for both the laser source and the light valve, the solution is expensive to implement and maintain. For example, problems still exist such as water purification needs, sedimentation in the water cooling lines, water leakage, and the requirement for relatively large and expensive piping networks to effectively cool the components of the imaging head.

Furthermore, various components of a laser imaging system present different thermal loads necessitating different degrees of cooling. Some workers have simply employed separate, dedicated cooling systems for each laser component, each cooling system having unique cooling capabilities.

U.S. Pat. No. 3,569,860 to Booth, and U.S. Pat. No. 5,327,442 to Yarborough et al both teach such a design. Both Booth and Yarborough use separate cooling systems to cool a laser gain medium such as a rod(s), and a flash lamp(s) for pumping the rod(s). This approach, though technically adequate for cooling purposes, is expensive, complex, and requires a large floor space. Further, multiple, separate cooling systems are often too bulky to include in a platesetter for making printing plates.

U.S. Pat. No. 5,781,574 to Connors et al teaches a method of cooling a plurality of lasers using a heat exchanger. The system taught by the '574 patent is effective because Connors teaches using four individual lasers that are pulsed on and off at a low duty cycle and “adding” the output beams together into a single beam. This prevents generation of large amounts of heat at a significant increase in cost, complexity, and shear volume of parts. With such little heat generated in this manner, a simple heat exchanger may be employed as taught by Connors to cool the plurality of lasers.

Other attempts to cool multiple laser components (e.g. laser rod, and/or laser flash lamp) presenting different thermal loads, use a single cooling system, but require insulating a laser component from the coolant as described in U.S. Pat. No. 5,848,081 to Reed et al. This technique applies a portion of the cooling capacity of a cooling system to an insulated laser rod, while allowing for the application of the remaining cooling capacity to an uninsulated flash lamp.

A similar method taught by Hill et al in U.S. Pat. No. 4,096,450 uses two separate cooling systems where one cooling system cools a flash lamp via conduction by surrounding a portion of the lamp with barium sulfate powder. The other system cools a laser rod by circulating coolant around the rod.

High powered lasers, as mentioned above, require significant cooling requirements. The Nolan '941 patent teaches water cooling for both the laser and the light valve, since conventional air cooling does not provide adequate cooling for a high-powered laser source.

A vortex tube is an effective, low cost air cooling device used for a variety of industrial spot and process cooling needs. With no moving parts, a vortex tube spins compressed air to separate the air into cold and hot air streams. A percentage of the hot air is permitted to exit at a control valve. The remainder of the slower, cool air stream is forced to counter-flow up through the center of the high-speed air stream, giving up heat, through the center of the generation chamber finally exiting through the opposite end as extremely cold air. Vortex tubes generate temperatures down to 100 degrees below inlet air temperature. A control valve located in the hot exhaust end can be used to adjust the temperature drop and rise for the vortex tube.

In addition to cooling requirements, the components of the imaging head such as the light valve, the laser source, optical wedges, prisms, mirrors, reflectors, etc. all work best under clean air conditions. When the air surrounding the components of the imaging head includes dust, dirt and other particles therein, these particles will sometimes tarnish or soil the components, or be burnt into the surface of one or more of the optical components by the laser beam, resulting in less than optimal performance of the imaging head.

There is a need to better solve the above shortcomings of the prior art and provide an imaging system for making printing plates that is more cost effective and compact, and which includes an imaging head with a clean air environment and adequate cooling of components of the head.

### SUMMARY OF THE INVENTION

A method for cooling and pressurizing a laser imaging head includes the steps of: providing the imaging head with components including a laser source, a light valve for modulating light from the laser source, and optics for transferring an image to a medium; enclosing the imaging head within a non-hermetically sealed enclosure; and providing a flow of cooled air at a predetermined cool air temperature and at a controlled positive air pressure into the sealed enclosure through an inlet from a vortex tube operating from compressed air, wherein the cooled air flow and the predetermined cooled air temperature are controlled by the vortex tube to maintain an operating temperature of the components within the imaging head within a predetermined operating range, and wherein the positive air pressure is maintained within the sealed enclosure with respect to ambient air pressure outside of the sealed enclosure due to the controlled flow of cooled air entering the sealed enclosure.

### BRIEF DESCRIPTION OF THE DRAWINGS

FIG. 1 (not drawn to scale) is a block diagram of a system in accordance with the principles of the invention.

### DETAILED DESCRIPTION OF THE PREFERRED EMBODIMENTS

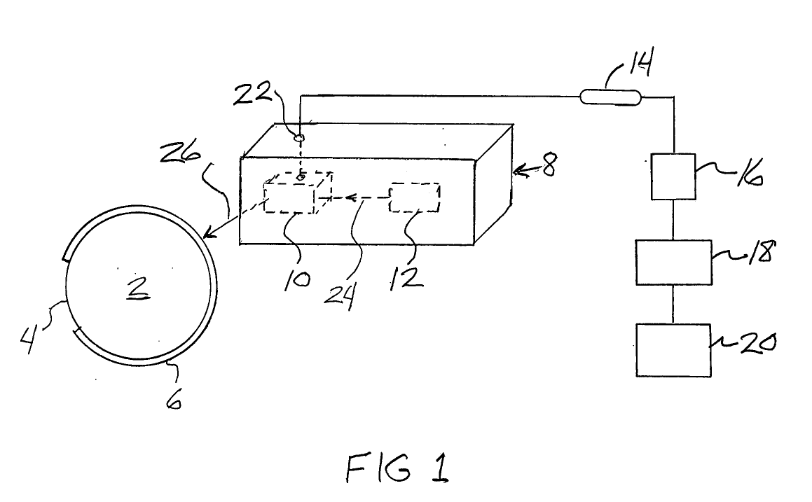

In a first preferred embodiment, FIG. 1 illustrates a portion of a system for imaging printing plates, i.e. a platesetter. A printing plate 6 which is mounted on an outside surface 4 of an external drum 2 of the platesetter for imaging. The imaging head 8 includes a laser source or power supply 12 which generates and supplies a laser beam 24 to the GLV light valve 10. The GLV light valve 10 modulates the laser beam 24 and send the modulated beam 26 to the medium 6 mounted on the external drum 2. In this case, the imaging head operates in the ultraviolet spectrum so that the laser beam generated will expose the UV printing plate 6 with ultraviolet light to yield an image transferred thereon.

Notice that the imaging head 8 is depicted as a non-hermetically sealed container. That is to say that all of the components within the imaging head 8, including the laser source 12 and the GLV modulator 10 are enclosed within the container as shown. However, the container of the imaging head may be put together, for instance, with nuts, bolts, screws, rivots, etc. so that none of the joints of the container are sealed either hermetically or with glues or other materials to make a complete air-tight enclosure.

The system in FIG. 1 also includes an air compressor 20, an air filter 18, a pressure regulator 16 and a vortex tube 14. The compressor 20 supplies compressed air without cooling to the air filter 18 which purifies the air and passes the cleaned air through the pressure regulator 16 which monitors the pressure of the air. The compressed air from regulator 16 is passed to the vortex tube 16 which cools the air to a predetermined temperature as desired by the operator of the system. The cooled air is passed from the vortex tube through an inlet 22 into the enclosure of the imaging head 8, and further to the GLV light valve where the cooled air maintains the GLV modulator within an acceptable temperature operating range.

The cooled air which enters the imaging head 8 fills the enclosure of the imaging head and the pressure therein is monitored and maintained in accordance with the pressure regulator 16 to ensure that a positive pressure is maintained within the enclosure of the imaging head 8 with respect to ambient air pressure outside of the sealed enclosure. In this way, there is a constant, controlled, air flow through the unsealed imaging head enclosure 8 which prevents dust particles and any other environmentally unclean or undesirable airborne particles from entering the imaging head from the outside, ambient environment where the platesetter or other machine having this imaging head is located.

While this invention has been particularly shown and described with references to preferred embodiments thereof, it will be understood by those skilled in the art that various form changes in and details may be made therein without departing from the spirit and scope of the invention as defined by the appended claims.

1. A method, comprising the steps of:
providing an imaging head having components including a laser source, a light valve for modulating light from the laser source, and optics for transferring an image to a medium;
enclosing the imaging head within a non-hermetically sealed enclosure; and
providing a flow of cooled air at a predetermined cool air temperature and at a controlled positive air pressure into the sealed enclosure through an inlet from a vortex tube operating from compressed air, said cooled air flow and the predetermined cooled air temperature being controlled by the vortex tube to maintain an operating temperature of the components within the imaging head within a predetermined operating range,
wherein the positive air pressure is maintained within the sealed enclosure with respect to ambient air pressure outside of the sealed enclosure due to the controlled flow of cooled air entering the sealed enclosure.

2. The method of claim 1, further comprising the step of filtering the compressed air that feeds the vortex tube.

3. The method of claim 1, further comprising the step of regulating the positive air pressure of the compressed air that feeds the vortex tube.

4. The method of claim 1, wherein the laser source emits violet light.

5. The method of claim 4 wherein a wavelength of the violet light is about 405 nanometers.

6. A method, comprising the steps of:
providing an imaging head having components including a laser source to generate a laser beam, a modulator for modulating the laser beam, and optics for directing the laser beam onto a printing plate mounted on an external drum platesetter, wherein said platesetter comprises a drum which rotates while the imaging head traverses linearly along a longitudinal axis of the drum so that the laser beam will transfer an image to the printing plate mounted on an external surface of the drum;
enclosing the imaging head within a sealed enclosure to protect the imaging head from accidental damage and from environmental contamination, said sealed enclosure being non-hermetically sealed;
providing a flow of cooled air at a predetermined cooled air temperature into the sealed enclosure through an inlet from a vortex tube operating from compressed air, said cooled air flow and temperature being controlled to maintain an operating temperature of the modulator of the imaging head within a predetermined operating range, and to maintain a positive air pressure within the sealed enclosure with respect to ambient air pressure outside of the sealed enclosure.

7. The method of claim 6 wherein the step of providing the flow of cooled air also maintains an operating temperature of the laser source.

8. The method of claim 6 wherein the step of providing the flow of cooled air also maintains an operating temperature of the optics.

9. The method of claim 6, further comprising the step of filtering the compressed air that feeds the vortex tube.

10. The method of claim 6, further comprising the step of regulating the positive air pressure of the compressed air that feeds the vortex tube.

11. The method of claim 6, wherein the laser beam has a wavelength of about 405 nanometers.
